(19) United States
(12) Patent Application Publication
(10) Pub. No.: US 2007/0043822 A1
(43) Pub. Date: Feb. 22, 2007

(54) Instant messaging prioritization based on group and individual prioritization

(76) Inventor: Sara Carlstead Brumfield, Austin, TX (US)

Correspondence Address: IBM CORP (YA);C/O YEE & ASSOCIATES PC, P.O. BOX 802333, DALLAS, TX, 75380, US

(21) Appl. No.: 11/207,114

(22) Filed: Aug. 18, 2005

(51) Int. Cl. G06F 15/16

(52) U.S. Cl. 709/207

(57) ABSTRACT

A method in a data processing system for prioritizing instant messaging chat sessions. Individuals and groups within a buddy list are given a priority, arranged in hierarchical order. A hierarchical list of chat session correspondents is created. A numerical prioritization value is assigned to each chat session correspondent based on the place in the buddy list hierarchy for the chat session correspondent. Two individuals that are members of the same group have the same assigned priority. If a chat session is active, a chat session priority is designated for the chat session based upon the numerical prioritization value assigned to the chat session correspondent. An indicator setting from an indicator reference table is assigned to the chat session based on the chat session priority. A chat session indicator is adjusted for the chat session based upon the assigned indicator setting from the indicator reference table for the chat session.

### BACKGROUND OF THE INVENTION

1. Field of the Invention

The present invention relates generally to an improved data processing system and, in particular, to a method, system and computer program product for optimizing performance in a data processing system. Still more particularly, the present invention provides a method, system, and computer program product for instant messaging prioritization based on group and individual prioritization.

2. Description of Related Art

Instant Messaging (IM) is a type of communications service that enables a computer user to create a kind of private chat room with another individual in order to communicate in real time over the Internet. IM is similar to a telephone conversation, but uses text-based communication instead of voice-based communication. Typically, the IM system alerts the user whenever somebody on the user's private list of correspondents is online. The user can then initiate a chat session with that particular correspondent.

IM provides a convenient real-time and low cost communication channel among coworkers, customers, and suppliers. Instant Messaging can save time and money on long-distance phone bills. IM replaces telephone calls more often than it does e-mail, as it augments e-mail, but does not supplant e-mail.

However, as Instant Messaging becomes pervasive for users, they start to encounter situations where an individual user has many simultaneous chats going on with a number of correspondents at one time. Managing all of these chats is difficult. A user can currently tell to which correspondent she owes a response, but the IM system does not help its user to prioritize all chat sessions requiring responses;

Therefore, it would be advantageous to have a method, system, and computer program product to prioritize Instant Messaging chat sessions.

### SUMMARY OF THE INVENTION

The present invention is a method, system, and computer program product in a data processing system for instant messaging chat session prioritization based on group and individual prioritization. Individuals and groups within a buddy list are given a priority, arranged in hierarchal order. A hierarchical list of individual chat session correspondents is created. A numerical prioritization value is assigned to each chat session correspondent based on their place in the buddy list hierarchy. Two individuals that are members of the same buddy group have the same assigned priority. If a chat session is active, a chat session priority is designated for the chat session based upon the numerical prioritization value assigned to the chat session correspondent. An indicator setting from an indicator reference table is assigned to the chat session based on the chat session priority. A chat session indicator is adjusted for the chat session based upon the assigned indicator setting from the indicator reference table for the chat session.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented, according to a preferred embodiment of the present invention;

FIG. 2 is a block diagram of a data processing system that may be implemented as a server in which the present invention may be implemented, according to a preferred embodiment of the present invention;

FIG. 3 is a block diagram illustrating a data processing system in which the present invention may be implemented, according to a preferred embodiment of the present invention;

FIG. 4 is a block diagram illustrating components used in prioritizing instant messaging chat sessions in accordance with a preferred embodiment of the present invention;

FIG. 5 is a block diagram illustrating a prioritization table used in prioritizing instant messaging chat sessions in accordance with a preferred embodiment of the present invention; and

FIG. 6 is a flowchart illustrating the process used in prioritizing instant messaging chat sessions in accordance with a preferred embodiment of the present invention.

### DETAILED DESCRIPTION OF THE PREFERRED EMBODIMENT

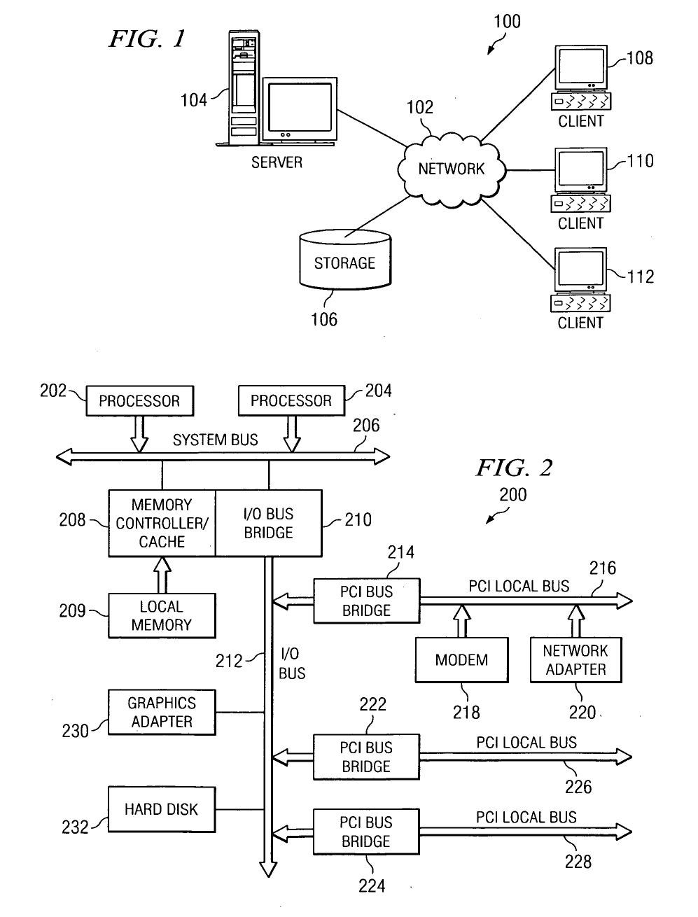

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

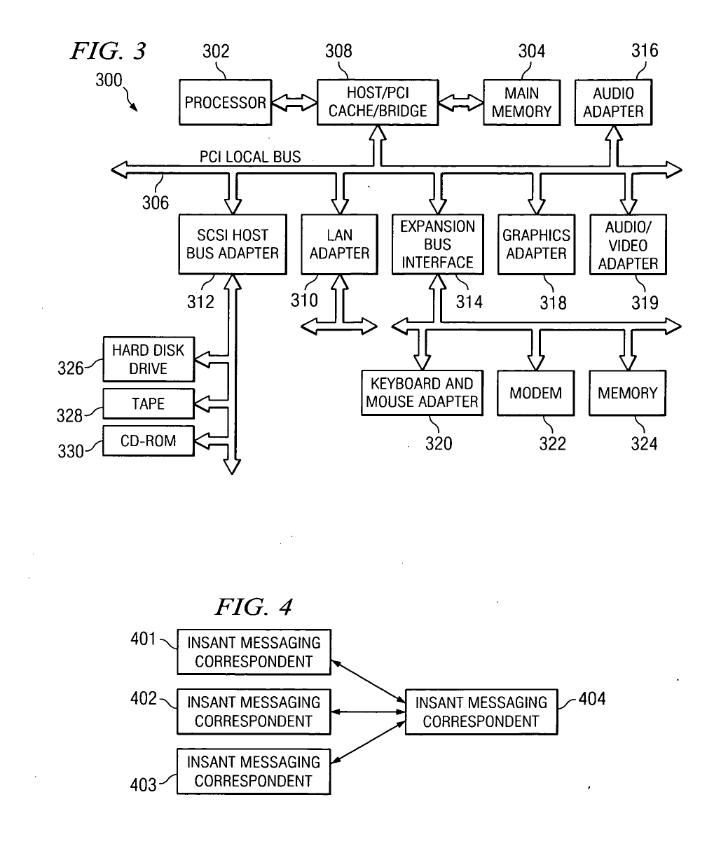

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning now to FIG. 4, a block diagram illustrating components used in an Instant Messaging system in accordance with a preferred embodiment of the present invention is shown. In this illustrative example, a user at Instant Messaging client 401 may send or exchange messages with other correspondents at Instant Messaging clients 402 and 403. These IM clients may be executing on a data processing system, such as data processing system 300 in FIG. 3. The exchange of messages in these examples is facilitated through Instant Messaging server process 404. This process allows for a user to find correspondents within the IM system as well as aid in the exchange of messages between different correspondents.

Depending on the particular IM system, Instant Messaging server process 404 may only be involved in providing an indication of when particular correspondents are online and for establishing initial contacts, while a user contacting correspondents already on a buddy list may contact those correspondents directly after seeing that a particular correspondent is online. Instant Messaging server process 404 may be located on a server, such as data processing system 300 in FIG. 3.

Combined with an indication system, the mechanism of the present invention prioritizes all active IM chat sessions based on a hierarchy the user sets up in advance. This prioritization hierarchy is based upon an assigned priority for individual correspondents, based on their place as individuals or members of groups in the hierarchy on the same IM system. Two individuals that are members of the same group have the same assigned priority. When multiple IM chat sessions are active, there is an indicator for each IM chat sessions that helps the user decide the order in which the user should respond to correspondents based on the previously set prioritization hierarchy.

For example, the indication system may be similar to one such as the indication system disclosed in co-pending U.S. Patent Application Ser. No. ______ (Attorney Docket No. AUS920040671US1) entitled “Method and Apparatus for Instant Messaging Prioritization”, filed on Sep. 30, 2004, which describes a method whereby the Instant Messaging chat sessions that have been waiting the longest for a reply are indicated by a “flash speed” and/or a color. For the “flash speed” indicator, the longer the IM chat session has been waiting for a reply, the faster the visual representation of that session will flash. For a color indicator, the longer the IM chat session has been waiting for a reply, the “warmer” the color of visual representation of that IM chat session. Colors may range from “least warm” yellow to orange to “warmest” red. These are examples of typical indicators, but other types of indicators may also be used, such as sound indicators. As applied to the present invention, this indication system may be used to indicate which of the active IM chat sessions has the highest priority for a response, based upon a priority value the user has pre-assigned for each correspondent, individual or group, with whom the user chats.

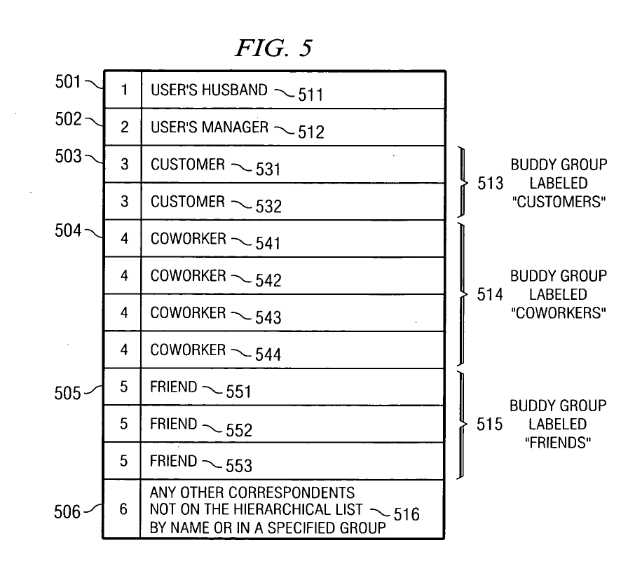

FIG. 5 is a block diagram of a prioritization table for prioritizing Instant Messaging chat sessions in accordance with a preferred embodiment of the present invention. The prioritization table in FIG. 5, which may be stored in memory, a data structure, etc., is shown to contain five correspondents/groups of correspondents, with 1 being the highest priority assigned in the hierarchy. In this example, the user may use the mechanism of the present invention to create hierarchical prioritization table 500 that starts with numerical prioritization value of 1 501 for user's husband 511, numerical prioritization value of 2 502 for user's manager 512, numerical prioritization value of 3 503 for all individuals in the buddy group labeled “customers” 513, numerical prioritization value of 4 504 for all individuals in the buddy group labeled “coworkers” 514, and numerical prioritization value of 5 505 for all individuals in the buddy group labeled “friends” 515.

In this example, the user has two customers in buddy group labeled “customers” 513, customer 531 and customer 532. Each member of a group has the same numerical prioritization value as the members of their buddy group, such that customer 531 and customer 532 would all have numerical prioritization value of 3 503, the numerical prioritization value of buddy group labeled “customers” 513.

In this example, the user has three coworkers in buddy group labeled “coworkers” 514, coworker 541, coworker 542, coworker 543, and coworker 544. Each member of a group has the same numerical prioritization value as the members of their buddy group, such that coworker 541, coworker 542, coworker 543, and coworker 544 would all have numerical prioritization value of 4 504, the numerical prioritization value of buddy group labeled “coworkers” 514.

In this example, the user has three friends in buddy group labeled “friends” 515, friend 551, friend 552, and friend 553. Each member of a group has the same numerical prioritization value as the members of their buddy group, such that friend 551, friend 552, and friend 553 would all have numerical prioritization value of 5 505, the numerical prioritization value of buddy group labeled “friends” 515.

Any other correspondents not on the prioritization list by name or in a specified group fall in priority below the identified priority correspondents on the list, unless the user selects an option to include the “all others” group anywhere in the hierarchy. In this example, any other correspondents not on the prioritization list by name or in a specified group 516 have numerical prioritization value of 6 506.

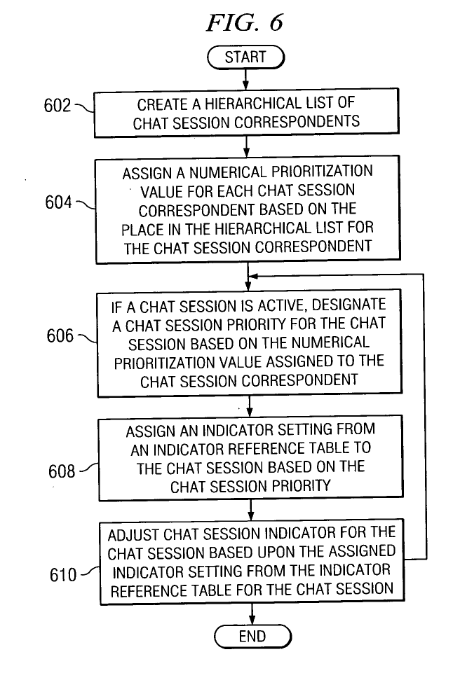

FIG. 6 is a flowchart of the process for prioritizing instant messaging chat sessions in accordance with a preferred embodiment of the present invention. The user assigns a priority to individuals or groups in their buddy list to create a hierarchal list through an IM chat session management user interface, wherein the list includes at least one IM chat session correspondent (step 602). When the chat software is started, a numerical prioritization value is assigned to each correspondent by creating or adding to a prioritization lookup table, which may be stored in memory, a data structure, etc., that contains all correspondents. Each individual IM chat session correspondent is assigned a numerical prioritization values based on the IM chat session correspondent's place in the hierarchal buddy list (step 604). All correspondents of the same group have the same numerical prioritization value based upon where the group is in the hierarchical list.

If IM chat sessions are active, the mechanism of the present invention designates an IM chat session priority for each IM chat session based upon which IM chat session correspondent the IM chat session is with and the numerical prioritization value assigned to the IM chat session correspondent (step 606). For example, the user may have an active IM chat session with user's manager 512, who has numerical prioritization value of 2 502 in priority table 500 and an active IM chat session with coworker 542, who as a member of buddy group labeled “coworkers” 514 in priority table 500 has numerical prioritization value of 4 504 because all group correspondents in buddy group labeled “coworkers” 514 have numerical prioritization value of 4 504.

If the user has selected the absolute priority option, the following designations would be made. Because numerical prioritization value of 2 502 for the IM chat session with user's manager 512 is the highest numerical prioritization value for an active IM chat session, the highest IM chat session priority indicator setting of 2 is designated for the IM chat session with user's manager 502. Because numerical prioritization value of 4 504 for coworker 542, who as a member of buddy group labeled “coworkers” 514 is the next highest numerical prioritization value for an active IM chat session, the next highest IM chat session priority indicator setting of 4 is designated for the IM chat session with coworker 542.

If the user has selected the relative priority option, the following designations would be made. Because numerical prioritization value of 2 502 for the IM chat session with user's manager 512 is the highest numerical prioritization value for an active IM chat session, the highest IM chat session priority indicator setting of 1 is designated for the IM chat session with user's manager 502. Because numerical prioritization value of 4 504 for coworker 542, who as a member of buddy group labeled “coworkers” 514 is the next highest numerical prioritization value for an active IM chat session, the next highest IM chat session priority indicator setting of 2 is designated for the IM chat session with coworker 542.

The IM chat session priorities are used to assign appropriate indicator settings from an indicator reference table, which may be stored in memory, a data structure, etc., such as color and/or flash speed, to each IM chat session (step 608). For example, using the absolute priority option, the IM chat session with the priority of 2 has the highest IM chat session priority, and is assigned the second “warmest” color orange, while the IM chat session with the priority of 4 has the fourth highest IM chat session priority, and is assigned the fourth “warmest” color white. In another example, using the relative priority option, the IM chat session with the priority of 2 has the highest IM chat session priority, and is assigned the fastest flash speed, while the IM chat session with the priority of 4 has the next highest IM chat session priority, and is assigned the next fastest flash speed.

In yet another example, using a length of wait for reply option, the IM chat session with an initial priority of 3 has been waiting for a reply longer than a specified wait length while the IM chat session with an initial priority of 2 has not been waiting for a reply longer than a specified wait length. The IM chat session with the initial priority of 3 and the long wait time is adjusted to a higher priority than the IM chat session with the initial priority of 2 and the short wait time. Therefore, the IM chat session with the initial priority of 3 is assigned the fastest flash speed, while the IM chat session with the initial priority of 2 has the next highest IM chat session priority, and is assigned the next fastest flash speed.

The IM chat session indicator is adjusted for each IM chat session based upon the assigned indicator setting from the indicator reference table, which may be stored in memory, a data structure, etc., for each IM chat session, such as color and/or flash speed (step 610). For example, using the relative priority option, because the IM chat session with user's manager 502 has the highest IM chat session priority of 1, IM chat sessions with the priority of 1 have the highest IM chat session priority, and IM chat sessions with the highest priority are assigned the “warmest” color red, the IM chat session indicator for user's manager 502 is assigned the “warmest” color red. Because the IM chat session with coworker 542 has the next highest IM chat session priority of 2, IM chat sessions with priority of 2 have the next highest IM chat session priority, and IM chat sessions with the next highest priority are assigned the next “warmest” color orange, the IM chat session indicator for coworker 542 is assigned the next “warmest” color orange. In another example, using the absolute priority option, because the IM chat session with user's manager 502 has a priority of 2, and IM chat sessions are assigned a flash speed corresponding to their prioritization on the hierarchal list, regardless of other active chat session, the IM chat session with user's manager 502 is assigned the second fastest flash speed available. Because the IM chat session with coworker 542 has an absolute priority of 4, it would be assigned the fourth fastest flash speed.

When a new chat session becomes active, using the absolute priority option, the chat session would get an indicator corresponding to its place on the hierarchal list. Using the relative priority option, all active chat sessions would be re-evaluated to ensure that their priority and indicator align with the new set of active chat sessions and their priorities.

Altogether, the process as shown in FIG. 6 provides an improved method to prioritize instant messaging chat sessions requiring responses.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for prioritizing instant messaging chat sessions, the method comprising:
creating a hierarchical list of chat session correspondents;
assigning a numerical prioritization value to a chat session correspondent based on a place in the hierarchical list for the chat session correspondent;
if a chat session is active, designating a chat session priority for the chat session based upon the numerical prioritization value assigned to the chat session correspondent;
assigning an indicator setting from an indicator reference table to the chat session based on the chat session priority; and
adjusting a chat session indicator for the chat session based upon the assigned indicator setting from the indicator reference table for the chat session.

2. The computer implemented method of claim 1 wherein the hierarchical list of chat session correspondents includes at least one individual correspondent.

3. The computer implemented method of claim 1 wherein the hierarchical list of chat session correspondents includes at least one group of correspondents.

4. The computer implemented method of claim 1 wherein the indicator setting includes at least one of an indicator flash speed, an indicator color, and an indicator sound.

5. The computer implemented method of claim 1 wherein an absolute priority based on an entire hierarchy is used to designate the chat session priority.

6. The computer implemented method of claim 1 wherein a relative priority relative to a set of active chat sessions is used to designate the chat session priority.

7. The computer implemented method of claim 6 wherein the relative priority relative to the set of active chat sessions is used to designate the chat session priority after the set of chat sessions includes a new chat session.

8. The computer implemented method of claim 1 wherein selecting a wait length for reply of a chat session option adjusts an initial chat session priority to a higher chat session priority relative to the initial chat session priority if a wait length for reply of the chat session is longer than a specified wait length.

9. A data processing system for prioritizing instant messaging chat sessions, the data processing system comprising:
a bus,
a storage device connected to the bus, wherein the storage device contains computer usable code;
a communications unit connected to the bus; and
a processing unit connected to the bus, wherein the processing unit executes the computer usable code to create a hierarchical list of chat session correspondents;
assign a numerical prioritization value to a chat session correspondent based on a place in the hierarchical list for the chat session correspondent;
if a chat session is active, designate a chat session priority for the chat session based upon the numerical prioritization value assigned to the chat session correspondent;
assign an indicator setting from an indicator reference table to the chat session based on the chat session priority; and
adjust a chat session indicator for the chat session based upon the assigned indicator setting from the indicator reference table for the chat session.

10. The data processing system of claim 9 wherein the hierarchical list of chat session correspondents includes at least one individual correspondent.

11. The data processing system of claim 9 wherein the hierarchical list of chat session correspondents includes at least one group of correspondents.

12. The data processing system of claim 9 wherein the indicator setting includes at least one of an indicator flash speed, an indicator color, and an indicator sound.

13. The data processing system of claim 9 wherein an absolute priority based on an entire hierarchy is used to designate the chat session priority.

14. The data processing system of claim 9 wherein a relative priority relative to a set of active chat sessions is used to designate the chat session priority.

15. The data processing system of claim 14 wherein the relative priority relative to the set of active chat sessions is used to designate the chat session priority after the set of chat sessions includes a new chat session.

16. The data processing system of claim 9 wherein the processing unit further executes the computer usable code to select a wait length for reply of a chat session option to adjust an initial chat session priority to a higher chat session priority relative to the initial chat session priority if a wait length for reply of the chat session is longer than a specified wait length.

17. A computer program product for prioritizing instant messaging chat sessions, the computer program product comprising:
a computer usable-medium having computer usable program code embodied therein;
computer usable program code configured to create a hierarchical list of chat session correspondents;
computer usable program code configured to assign a numerical prioritization value to a chat session correspondent based on a place in the hierarchical list for the chat session correspondent;
if a chat session is active, computer usable program code configured to designate a chat session priority for the chat session based upon the numerical prioritization value assigned to the chat session correspondent;
computer usable program code configured to assign an indicator setting from an indicator reference table to the chat session based on the chat session priority; and
computer usable program code configured to adjust a chat session indicator for the chat session based upon the assigned indicator setting from the indicator reference table for the chat session.

18. The computer program product of claim 17 wherein the hierarchical list of chat session correspondents includes at least one individual correspondent.

19. The computer program product of claim 17 wherein the hierarchical list of chat session correspondents includes at least one group of correspondents.

20. The computer program product of claim 17 wherein the indicator setting includes at least one of an indicator flash speed, an indicator color, and an indicator sound.
